(19) United States
(12) Patent Application Publication
(10) Pub. No.: US 2005/0117074 A1
(43) Pub. Date: Jun. 2, 2005

(54) Method of correcting perturbations in the picture signal of a color projection system, and such a color projection system

(75) Inventor: Adrianus Johannes Stephanes Maria De Vaan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/503,250

(22) PCT Filed: Jan. 27, 2003
(86) PCT No.: PCT/IB03/00245

(30) Foreign Application Priority Data
Feb. 5, 2002 (EP) 02075468.5

(51) Int. Cl. H04N 3/22

(52) U.S. Cl. 348/745

(57) ABSTRACT

The invention relates to a method of correcting perturbations in a picture signal of a color projection system which is provided with a light modulation panel comprising a large number of pixels arranged in a matrix of m×n rows. The light modulation panel is projected on a screen by a projection lens, and simultaneously illuminated by curved light spots of two or more colors. The light spots are moved across the light modulation panel and the pixels are driven row by row for projecting the picture signal. The invention also relates to a color projection system comprising a light source, an optical system comprising lenses and mirrors, means for splitting a light beam from the light source into several bars of different colors, a light modulation panel provided with a large number of pixels arranged in a matrix of m rows and n columns, a projection lens, and driving means for driving the pixels row by row for projecting information.

The invention relates to a method of correcting perturbations in the picture signal of a color projection system, in which a light modulation panel comprising a large number of pixels arranged in a matrix of m×n rows is projected by a projection lens, and in which the light modulation panel is simultaneously illuminated with curved light spots of two or more colors, which light spots are moved across the light modulation panel and the pixels are driven row by row for projecting the picture signal.

The invention also relates to a color projection system for performing the method as described in the opening paragraph, which color projection system comprises at least one light source, at least one system of lenses and mirrors arranged in front of the light source, at least means, arranged between the light source and the system, having a plurality of differently colored bars for splitting up a light signal emitted by the light source into a plurality of differently colored light beams, at least one light modulation panel comprising a large number of pixels arranged in a matrix of m×n rows and columns, a projection lens, and drive means for driving the elements row by row for projecting the information.

Such a color projection system is known, for example, from the published patent application WO 0065845 in the name of the applicant (internal reference 600351), in which the means for splitting up the light beam are formed by a rotatable color wheel provided with a plurality of spiralized bars for splitting the light beam emitted by the light source into differently colored light beams, in which the colors of the bars may be red, blue and green. Due to the relatively fast rotation of the color filter, the red, blue and green part of the picture signal to be projected is generated on each part of the light modulation panel and projected via the projection lens on the projection screen. By projecting the three different elementary colors of the picture signal rapidly one after the other, the human eye observes a fully colored picture.

In contrast to the standard color wheel, in which the light beam is only incident through one of the color filter elements and thus illuminates the total light modulation panel with light of one color only, the color wheel having the spiralized color bars splits up the light beam simultaneously into light spots having separate colors, which light spots are simultaneously imaged on the light modulation panel.

The spiral-shaped color bars have, however, the drawback that the light bars imaged on the light modulation panel are not straight but have a curved shape. Since the curved bars are imaged in a curved shape on the light modulation panel, the light modulation panel is to be driven with black bands between the separate color parts. A solution for reducing the curvature of the color bars is the enlargement of the color wheel so that the shape of the color bars more approximates the shape of straight bands. Upgrading the dimensions of the color wheel is, however, limited by the desired build-in space for the projection system.

It is an object of the invention to obviate the above-mentioned drawback and the method according to the invention is characterized in that the curvature in the colored light beams is corrected in the light modulation panel. Since the curvature is corrected in the imaging part of a color projection system, being the light modulation panel, as a result of the spiralized color bars of the color wheel, and is not corrected on the illumination side, the components on the illumination side and notably the-color wheel can be given a smaller shape so that a considerable build-in space can be gained. All this also results in a lower cost price.

In an embodiment of the method according to the invention, the pixels of the light modulation panel are driven in a curved line.

According to the invention, the light modulation panel is characterized in that correction means are provided which correct the curvature in the differently colored light beams.

In a specific embodiment, the correction means may form part of the drive means of the pixels of the light modulation panel, in which more particularly the drive means drive the pixels in curved lines in the matrix.

In another embodiment of the color projection system according to the invention, which has proved to be very effective, it is characterized in that the correction means form part of the matrix of pixels in which, more particularly, the rows of pixels are incorporated in a curved configuration in the matrix.

The means for splitting up the light signal emitted by the light source into a plurality of differently colored light beams may consist of a color filter which is rotatable about a shaft and comprises a plurality of differently colored spiral-shaped bars.

These and other aspects of the invention are apparent from and will be elucidated with reference to the embodiments described hereinafter.

In the drawings:

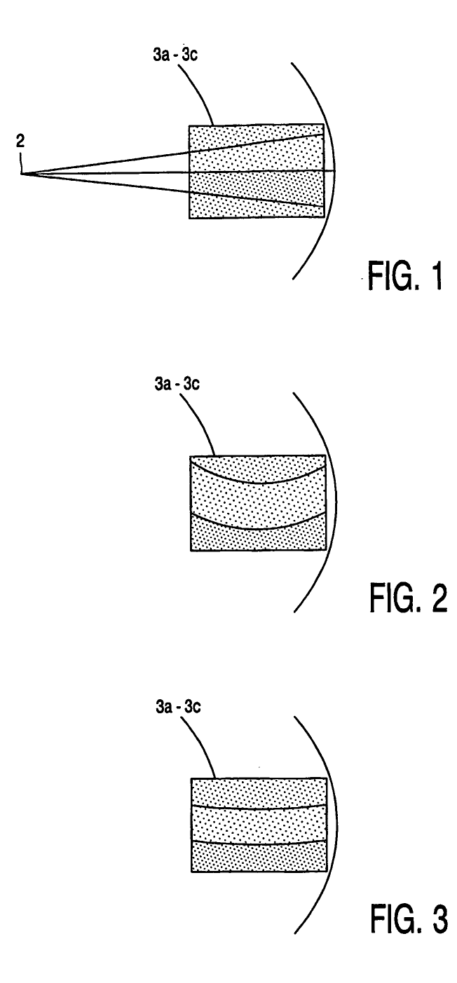

FIG. 1 shows diagrammatically the shape of color bands in the picture signal to be projected, obtained with a color wheel having straight color bars;

FIG. 2 shows diagrammatically the shape of the color bands in the picture signal to be projected, obtained with a known color wheel provided with spiral-shaped color bars;

FIG. 3 shows diagrammatically the shape of the color bands in the picture signal to be projected, obtained with a color wheel having spiral-shaped color bars of relatively larger dimensions;

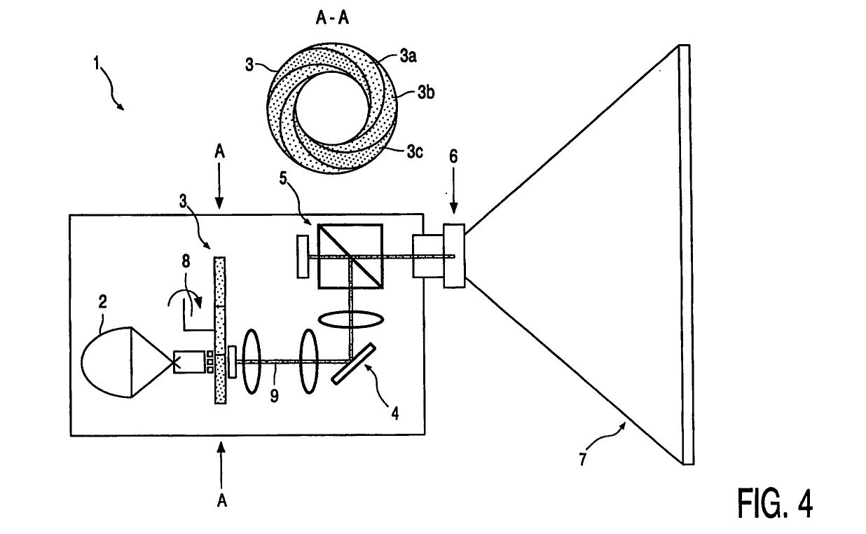

FIG. 4 shows an embodiment of a color projection system according to the invention;

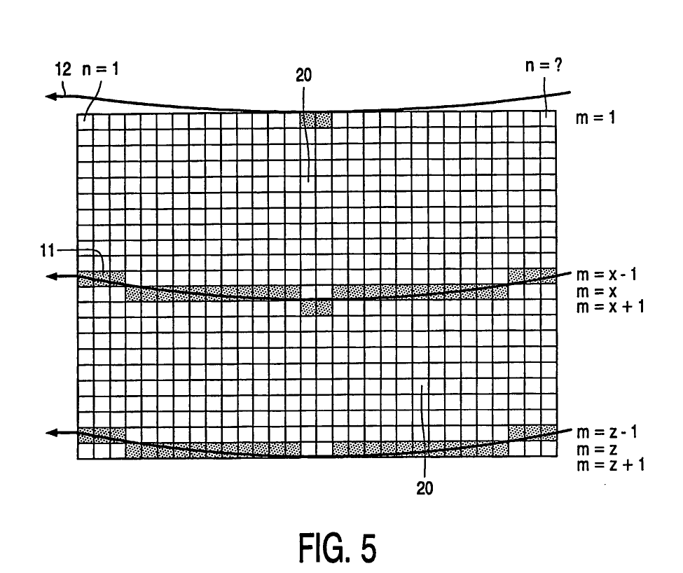

FIG. 5 is a front view of the light modulation panel of the color projection system shown in FIG. 4, in which the method according to the invention is shown diagrammatically.

FIG. 4 shows a color projection system which is suitable for performing the method according to the invention. The color projection system 1 comprises a light source 2, a rotatable color wheel 3, a system 4 consisting of lenses, mirrors and a polarization-dependent beam splitter 5, an electro-optical light modulation panel 10, a projection lens 6 arranged at least in front of the light modulation panel 10, and a projection screen 7.

The color wheel 3 is disc-shaped and can be rotated about a shaft 8 by suitable drive means. As is shown in the enlarged part A-A in FIG. 4, the color wheel 3 has a plurality of color bars 3a-3c, i.e. 3 in this embodiment, for the elementary colors red, green and blue. The light beam 9 emitted by the light source 2 is incident on the rotating color wheel 3 so that the light beam is split up into separate spiral-shaped color bands whose colors correspond to the colors of the spiral-shaped color bars 3a-3c. The color bands 9 pass through a system 4 consisting of consecutive lenses, mirrors and a polarization-dependent beam splitter 5 before being incident on a light modulation panel 10.

The color pattern generated by the color wheel 3 is imaged on the light modulation panel 10 after passing through the system of mirrors and lenses and after passing through the PBS 5. This light spot imaged on the light modulation panel 10 exhibits bent bars, with each bar being filled with light of the desired color red, green and blue. Simultaneously, an image comprising the parts of the picture signal to be projected which are relevant for the respective colors is generated on the light modulation panel 10. The picture signal generated on the light modulation panel 10 is subsequently imaged on the projection screen 7 by means of the projection lens 6.

By rotating the color wheel 3, the red, green and blue light bands are scanned across the light modulation panel 10 and, accordingly, the picture signal generated on the light modulation panel 10 is adapted. Due to the rapid rotation of the color wheel 3 and simultaneously adapting the picture signal generated on the light modulation panel 10 in synchronism therewith, the red, green and blue part of an entire image can be projected time-sequentially in a relatively rapid succession. At a sufficiently high speed, a viewer can no longer observe the separate color flashes and a color image which is free from vibrations and flicker will be observed.

In addition to the three elementary colors, the color wheel may also have a white spiral-shaped bar.

In an embodiment of the color wheel 3, which has been known for a longer time, the alternating red, green and blue bars 3a-3c extend parallel to each other. This color wheel is used in projection systems in which the pattern of the color wheel is not directly imaged on the light modulation panel but in which the color wheel is placed at such a position in the projection system that the light modulation panel is illuminated with the consecutive flashes of red, green and blue light. When such a color wheel is used in a system in which all of the three basic colors red, green and blue must be simultaneously incident on the light modulation panel, the pattern of the color wheel must be imaged on the light modulation panel in such a way that each light of each basic color is incident on a part of the light modulation panel. If the known embodiment of the color wheel 3 is used for this purpose, in which the alternating red, green and blue bars 3a-3c extend parallel to each other, the result is that the split colored light beams are wedge-shaped, as is shown in FIG. 1.

In the embodiment of the color wheel 3, which is also known, and in which the different color bars are situated in a spiral shape in the color wheel, a more symmetrically formed split colored light beam is created which, however, will still have a curved shape as is shown in FIG. 2. Since the picture signal is distorted with both the wedge-shaped and the curved split light beams, which distortion has a detrimental influence on the ultimately projected picture, there is a solution for correcting this distortion by relatively enlarging the color wheel 3 so that the split color beams have a “straighter” shape. This is shown in FIG. 3. However, upgrading the dimensions of the color wheel 3 in this embodiment is unwanted in many situations because it does not yield a reduction of the build-in space.

It is an object of the invention to provide a solution to the distortion in the picture signal in the current color projection systems, which solution is not sought on the illumination side but on the imaging side. Consequently, the color projection system may be relatively compact and inexpensive while using standard components on the image creating side.

The screen panel built up of a matrix of m×n rows and columns of pixels in which the picture signal is written row by row for correcting the curvature in the split color beams is driven in such a way that the picture signal is written row by row, which rows have a curvature compensating the curvature in the colored split light beams.

This is shown in FIG. 5 in which the matrix of m×n rows and columns of pixels has an orthogonal system. In contrast to the known drive of such a matrix of pixels, the picture signal is not written per straight orthogonal row in the matrix field, but the matrix field of pixels is driven in such a way that each picture line is written in a curvature across a plurality of orthogonal matrix rows. This is shown in FIG. 5 in which the picture line denoted by the reference numeral 11 is not written across a straight orthogonal matrix row but is written in a curved shape in pixels which are arranged in a curvature in three orthogonal matrix rows and are denoted in the matrix field by means of the ordinal numbers x−1, x and x+1.

Similarly, the first picture line 12 is also written in a curved shape, in which only two pixels in the first matrix row m+1 of the visible projection screen are driven. The pixels of the straight matrix rows situated above the matrix row m+1 are not visible to the viewer. Likewise, the picture line 13, which is to be written as the last picture line in the image signal, is written in the matrix of pixels in a curved shape across three straight matrix rows m=z−1, m=z, m=z+1, in which the picture line m=z+1 is situated outside the visible image plane of the projection screen.

The drive means driving the matrix field of pixels 20 are therefore not characterized, as in the prior art, by an orthogonal drive, but the drive means for each picture line are allocated to pixels distributed also in a curved line to pixels distributed across different matrix rows as a compensation for the curvature in the split color beams.

In another embodiment, in which the picture lines are also written in a curved shape for correcting the curvature in the split color beams, the matrix of pixels is not built up of an orthogonal system of rows and columns, but the pixels for each matrix row are incorporated in a curved shape themselves in the matrix field. Each row transistor then drives its associated matrix row, but since this matrix row is physically situated in a curvature in the matrix, each picture line is thus written in a curved shape and projected.

1. A method of correcting perturbations in the picture signal of a color projection system, in which a light modulation panel comprising a large number of pixels arranged in a matrix of m×n rows is projected by a projection lens, and in which the light modulation panel is simultaneously illuminated with curved light spots of two or more colors, which light spots are moved across the light modulation panel and the pixels are driven row by row for projecting the picture signal, characterized in that the curvature in the colored light beams is corrected in the light modulation panel.

2. A method as claimed in claim 1, characterized in that the pixels of the light modulation panel are driven in a curved line.

3. A color projection system for performing the method as claimed in claim 1, which color projection system comprises at least one light source, at least one system of lenses and mirrors arranged in front of the light source, at least means, arranged between the light source and the system, having a plurality of differently colored bars for splitting up a light signal emitted by the light source into a plurality of differently colored light beams, at least one light modulation panel comprising a large number of pixels arranged in a matrix of m×n rows and columns, a projection lens, and drive means for driving the elements row by row for projecting the information, characterized in that correction means are provided which correct the curvature in the differently colored light beams.

4. A color projection system as claimed in claim 3, characterized in that the correction means form part of the drive means of the pixels of the light modulation panel.

5. A color projection system as claimed in claim 4, characterized in that the drive means drive the pixels in curved lines in the matrix.

6. A color projection system as claimed in claim 3, characterized in that the correction means form part of the matrix of pixels.

7. A color projection system as claimed in claim 6, characterized in that the rows of pixels are incorporated in a curved configuration in the matrix.

8. A color projection system as claimed in claim 3, characterized in that the means for splitting the light signal emitted by the light source into a plurality of differently colored light beams consist of a color filter which is rotatable about a shaft and comprises a plurality of differently colored spiral-shaped bars.

9. A color projection system as claimed in claim 3, characterized in that the means for splitting the light signal emitted by the light source into a plurality of differently colored light beams consist of a color filter which is rotatable about a shaft and comprises a plurality of differently colored spiral-shaped bars.
